(19) United States
(12) Patent Application Publication
(10) Pub. No.: US 2022/0200372 A1
(43) Pub. Date: Jun. 23, 2022

(54) Electric Machine for Driving a Motor Vehicle

(71) Applicant: ZF Friedrichshafen AG, Friedrichshafen (DE)

(72) Inventors: Martin Lang, Wegscheid (DE); Thomas Auer, Passau (DE); Maria Lang, Hauzenberg (DE)

(21) Appl. No.: 17/554,634

(22) Filed: Dec. 17, 2021

(30) Foreign Application Priority Data
Dec. 18, 2020 (DE) 10 2020 216 225.5

(51) Int. Cl. H02K 1/20; H02K 1/32; H02K 9/06

(52) U.S. Cl. CPC H02K 1/20; H02K 9/06; H02K 1/32

(57) ABSTRACT

An electric machine (1) for driving a motor vehicle includes a stator (2) having a stator core (7), a stator cooling bush system (8), and a housing (4). The stator cooling bush system (8) externally surrounds the stator core (7) in a radial direction (r) of the electric machine (1), and the housing (4) externally surrounds the stator cooling bush system (8) in the radial direction (r) of the electric machine (1). The stator cooling bush system (8) forms a fluid duct (17). A fluid is flowable through the fluid duct (17) to receive heat from the stator core (7). The stator cooling bush system (8) forms at least one air duct (18, 18.1, 18.2) arranged separate from the fluid duct (17) between the stator cooling bush system (8) and the housing (4). Air is flowable through the at least one air duct (18, 18.1, 18.2).

### CROSS-REFERENCE TO RELATED APPLICATION

The present application is related and has right of priority to German Patent Application No. 102020216225.5 filed in the German Patent Office on Dec. 18, 2020, which is incorporated by reference in its entirety for all purposes.

### FIELD OF THE INVENTION

The invention relates generally to an electric machine for driving a motor vehicle.

### BACKGROUND

An electric machine that drives a motor vehicle is operated at high power levels. This also means, however, that a large amount of heat arises, which must be dissipated as waste heat from the electric machine as much as possible, in order, for example, not to damage bearings or a rotor shaft of the electric machine. In this context, EP 2109207 A2 discloses an electric machine having a machine housing, in which a rotor and a stator winding are accommodated, wherein the stator winding includes winding overhangs arranged on opposite sides, in a winding overhang space in each case, and having a cooling device, which includes a liquid cooling circuit having a stator casing cooling and cooling pipe coils, and having a fan connected to the rotor for circulating air in the machine housing. The heat arising in an electric machine due to the high power levels can also have a power-limiting effect. Once a certain winding overhang temperature has been reached, a control unit of the electric machine typically reduces power, which is also known as “derating”.

### SUMMARY OF THE INVENTION

Example aspects of the present invention can assist with better dissipating waste heat, in particular, of an electric machine of a motor vehicle using simple constructions.

Example aspects of the present invention provide a cooling concept for an electric machine of a motor vehicle. The electric machine can be utilized, in particular, for driving the motor vehicle, either alone or in combination with an internal combustion engine. According to example aspects of the present invention, a cooling concept is provided, according to which air that has absorbed heat, within the electric machine, from components to be cooled (for example, absorbing the heat while flowing through a rotor shaft of the electric machine), can optimally give off this heat externally into the surroundings at a water-cooled stator cooling bush and at a housing.

In this sense, according to a first example aspect of the invention, an electric machine is provided for driving a motor vehicle. The electric machine includes a stator having a stator core, a stator cooling bush system, and a housing. The stator cooling bush system surrounds the stator core in a radial direction of the electric machine, wherein the housing externally surrounds the stator cooling bush system in the radial direction of the electric machine. The stator cooling bush system forms a fluid duct, which is arranged within the stator cooling bush system, wherein a fluid (in particular a cooling water, for example, a mixture of water and antifreeze, such as Glysantin®, flows through the fluid duct and absorbs heat from the stator core. The stator cooling bush system also forms at least one air duct, which is arranged separated from the fluid duct between the stator cooling bush system and the housing. Air flows through the at least one air duct, wherein the air has previously absorbed heat from components of the electric machine to be cooled. The fluid that flows through the fluid duct, in turn, absorbs heat from the air that flows through the at least one air duct. The fluid duct can form, in particular, a portion or section of a cooling water circuit of the electric machine. This cooling water circuit includes, in particular, a heat exchanger and a pump, which can be arranged within the electric machine as well as outside the electric machine.

The air that has absorbed heat from the components of the electric machine to be cooled can also give off a portion of this heat to external surroundings of the electric machine via the housing, and so the air is re-cooled and, thereafter, can absorb heat again in order to continue to cool the elements of the electric machine (closed air circuit). Due to the fact that the air duct and the fluid duct are formed by the stator cooling bush system, a low number and complexity of components and, thereby, lower costs result. The stator cooling bush system can be inserted into a bore of the housing, wherein the bore is easy to produce by machining. In addition, the stator cooling bush system takes up a particularly small amount of installation space. The stator cooling bush system has optimal heat release properties, since the air flows very closely past the fluid flowing through the fluid duct and most of the heat is removed from the system via this fluid.

In one example embodiment, the stator cooling bush system is designed as two pieces and includes an inner stator cooling bush and an outer stator cooling bush. The inner stator cooling bush externally surrounds the stator core in the radial direction of the electric machine, wherein the outer stator cooling bush externally surrounds the inner stator cooling bush in the radial direction of the electric machine, and wherein the housing externally surrounds the external stator cooling bush in the radial direction of the electric machine. The inner stator cooling bush forms the fluid duct and the outer stator cooling bush forms the at least one air duct. With the aid of the outer stator cooling bush, preferably designed having air gaps/air ducts and ridges as a “diagonal bush” (i.e., diagonal ridges), an enormously large number of advantages for air cooling can be implemented in an easy way. For example, the outer stator cooling bush can seal off, via an inner surface of the outer stator cooling bush, the water cooling (fluid duct) of the inner stator cooling bush. Likewise the simplest sealing concept can be utilized, for example, using only two O-rings at end surfaces of the outer stator cooling bush and the inner stator cooling bush facing away from each other.

According to one further example embodiment, the air duct extends in an axial direction of the electric machine from a first end surface of the outer stator cooling bush up to a second end surface of the outer stator cooling bush, wherein the outer stator cooling bush forms a first ridge and a second ridge. The first ridge and the second ridge project outwardly from an outer lateral surface of the outer stator cooling bush in the radial direction of the electric machine, wherein the first ridge and the second ridge delimit the at least one air duct between them in a circumferential direction of the outer stator cooling bush. In addition, more than the two ridges can be provided, for example, a third ridge and a fourth ridge, which then delimit a corresponding plurality of cooling ducts between them. The ridges are distributed over the outer lateral surface, for example, equidistantly or in parallel to one another. The first ridge and the second ridge can project outwardly, in particular, in the radial direction, from the outer lateral surface in a particularly low manner, for example, a few millimeters, and can be spaced particularly wide apart from one another, for example, a multiple of ten (10) mm, and so very wide but low air ducts arise. The outer stator cooling bush then has optimal heat release properties, since the air can flow in very wide but low air gaps.

The first ridge and the second ridge can extend in a straight line and in parallel to the axial direction of the electric machine, and so the at least one air duct also extends in parallel to the axial direction of the electric machine.

It is particularly preferred when the ridges can extend diagonally (“diagonal bush”) along the lateral surface. Since the air begins to swirl due to the direction of rotation of the electric machine and a rotor shaft of the electric machine, a diagonal bush has particularly good flow properties for the air, which was validated by flow simulations carried out by the inventor. In this context, particularly good air flow properties are, in particular, small eddies, a small back-up, good inflow onto “hot” components, and few “blind spots” with regard to the inflow. In this context, according to one further example embodiment, the first ridge and the second ridge extend in a straight line and angled with respect to the axial direction of the electric machine, and so the at least one air duct extends diagonally along the outer lateral surface of the outer stator cooling bush.

Moreover, the first ridge and the second ridge can form a radially outer support surface, with which the outer stator cooling bush—and the elements of the electric machine located radially within the stator cooling bush—can rest against the housing of the electric machine. According to this example embodiment, the bushes and nearly the entire electric machine therefore rests against the motor housing via the ridges, for example, via a press fit with the housing of the electric machine. The stator cooling bush system does not necessarily need to be pressed into the motor housing, although this is preferable. It could also be a transition fit or a clearance fit and another machine element, for example, a pin, can ensure that the bush does not turn in the motor housing.

The cooling of the electric machine is particularly effective and efficient when an air cooling is enabled, according to which air circulates within the electric machine and, on the one hand, absorbs heat from components to be cooled, for example, from the winding overhangs or from a rotor shaft and, on the other hand, can give off the heat, in particular to the fluid in the fluid duct and to the external surroundings of the electric machine. The stator cooling bush system makes it possible, via the air gaps or via, for example, the at least one air duct, that an air circulation having a heat absorption area and a heat release area can arise. A circulating flow of air can be generated within the air circuit by a fan. In this sense, it is provided according to one further example embodiment that the electric machine includes a closed air circuit and a fan, which is arranged within the closed air circuit. The at least one air duct forms a section of the closed air circuit. The fan conveys air within the closed air circuit, i.e., the fan induces the circulation of air that is located within the closed air circuit.

It is particularly advantageous for the cooling of the electric machine when the air circulating within the closed air circuit can absorb heat from a rotor shaft of the electric machine. In this way, the air that is conveyed through the air circuit can flow through the rotor in open spaces of a, for example, cross-shaped or star-shaped rotor shaft. The air flows in the air circuit and, in so doing, can absorb heat in the rotor and give off the heat toward the outside via the housing or to the water-cooled inner stator cooling bush. In this sense, the electric machine can include a rotor having a rotor shaft and the air circuit can include a rotor air duct. The rotor air duct can extend through the rotor shaft, for example, in the axial direction of the electric machine. For this purpose, the rotor shaft can be formed in such a way that the rotor shaft forms at least one portion of the rotor air duct. For example, the rotor shaft can have a star-shaped or cross-shaped cross-section for this purpose, allowing open spaces to be formed, via which the air can flow through the rotor shaft. Alternatively, the rotor air duct can be formed by bores in the rotor itself. Air flowing in the rotor air duct absorbs heat from the rotor shaft and, as a result, cools the rotor shaft.

In order to enable an air cooling of winding overhangs of the stator, it is provided according to one further example embodiment that the air circuit includes a first winding overhang air duct and a second winding overhang air duct. The first winding overhang air duct extends along the first winding overhang, and so air that flows in the first winding overhang air duct absorbs heat from the first winding overhang. In a similar way, the second winding overhang air duct extends along the second winding overhang, and so air that flows in the second winding overhang air duct absorbs heat from the second winding overhang. The rotor air duct can be connected, at the two axial ends of the rotor air duct, to the first winding overhang air duct on the one hand and to the second winding overhang air duct on the other hand, wherein air flows out of the second winding overhang air duct into the rotor air duct, and wherein air flows out of the rotor air duct and into the first winding overhang air duct.

The housing of the electric machine can have an end-surface housing part, which at least partially closes the electric machine on a first axial end surface of the electric machine. According to this example embodiment, the first winding overhang air duct is at least partially formed by the end-surface housing part. In addition, the electric machine can have a housing cover on its other axial end surface. This housing cover can be distinguished, in particular, by the fact that the housing cover at least partially closes the electric machine on the second axial end surface, and that the housing cover simultaneously forms at least a portion of the second air duct.

According to a second example aspect of the invention, a motor vehicle is provided, which includes an electric machine according to the first example aspect of the invention. The motor vehicle can include an electric axle drive, which is driven by the electric machine. The electric machine is arranged in the motor vehicle in such a way that the motor vehicle can be driven by the electric machine when the electric machine is operated as a motor. In addition, the electric machine can be arranged within the motor vehicle in such a way that the electric machine is driven by the motor vehicle when the electric machine is operated as a generator. The vehicle is, for example, a commercial vehicle, an automobile (for example, a passenger car having a weight of less than three and a half tons (3.5 t)), a motorcycle, a motor scooter, a moped, a bicycle, an e-bike, a bus, or a truck (bus and truck, for example, having a weight of more than three and a half tons (3.5 t)), or also a rail vehicle, a ship, or an aircraft, such as a helicopter or an airplane. In other words, the invention is usable in all areas of transportation, such as automotive, aviation, nautical science, astronautics, etc. The motor vehicle can belong, for example, to a vehicle fleet. The motor vehicle can be controlled by a driver, possibly assisted by a driver assistance system. The motor vehicle can also be, for example, remotely controlled and/or (semi-)autonomously controlled, however.

### BRIEF DESCRIPTION OF THE DRAWINGS

Exemplary embodiments of the invention are explained in greater detail in the following with reference to the diagrammatic drawings, wherein identical or similar elements are labeled with the same reference numbers, wherein

FIG. 1 shows a longitudinal sectional representation of a portion of an electric machine according to example aspects of the invention,

FIG. 2 shows a perspective representation, in particular, of an inner stator cooling bush of the example electric machine according to FIG. 1,

FIG. 3 shows a perspective representation of an outer stator cooling bush of the example electric machine according to FIG. 1,

FIG. 4 shows a perspective representation of the inner and outer stator cooling bushes of the example electric machine according to FIG. 1, in an assembled condition,

FIG. 5 shows an enlarged representation, in particular, of the inner and outer stator cooling bushes of the example electric machine according to FIG. 1, according to an alternative sectional view,

FIG. 6 shows a side view of a motor vehicle, which can be driven by the example electric machine according to FIG. 1, and

FIG. 7 shows a top view of a drive train of a further motor vehicle, which can be driven by the example electric machine according to FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

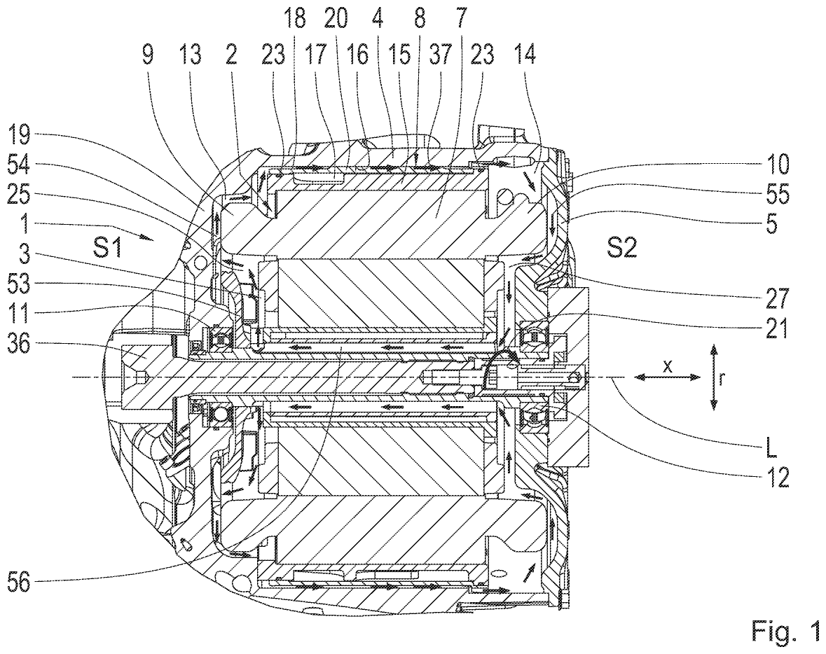

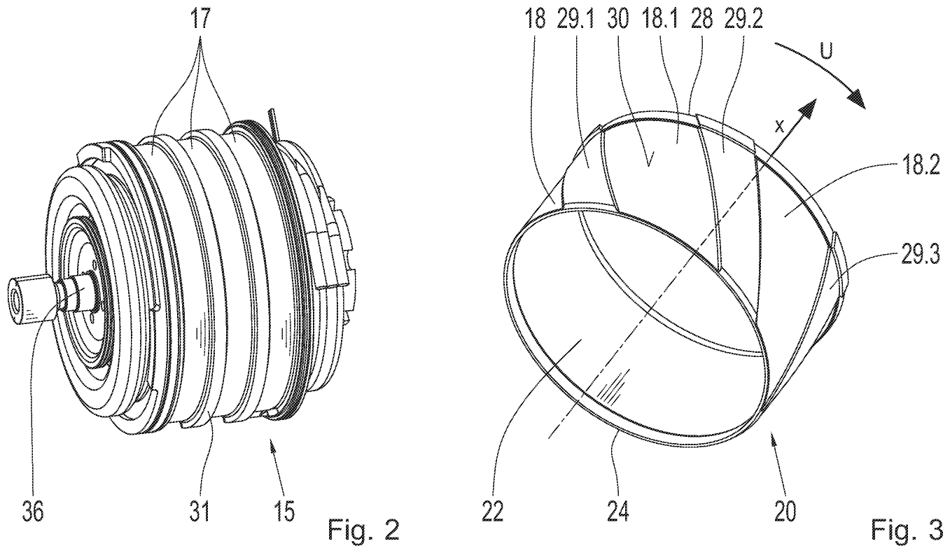

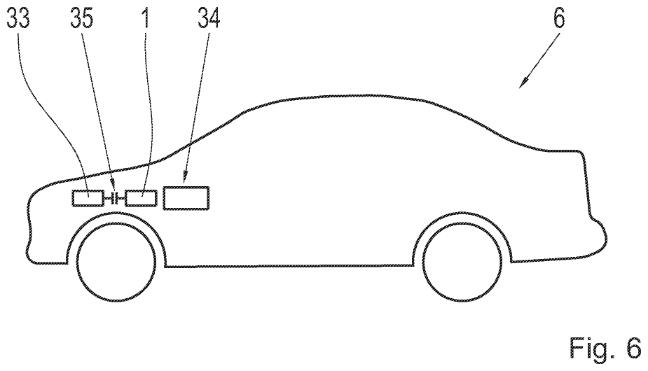

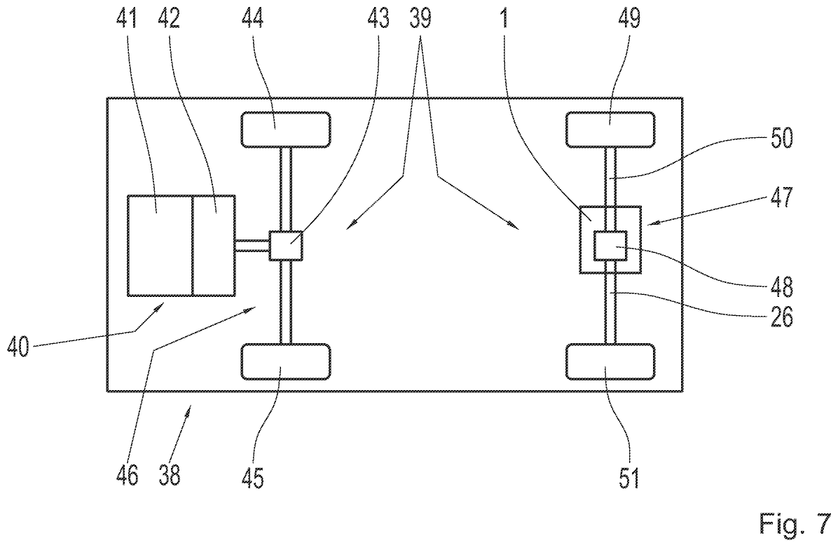

FIG. 1 shows an electric machine 1 having a stator 2 and having a rotor 3. The electric machine 1 also includes a housing 4 and a housing cover 5. The electric machine 1 can be operated as a motor and as a generator. The electric machine 1 can drive a motor vehicle 6/38, which is shown in FIG. 6 and FIG. 7, respectively.

When the electric machine 1 is operated as a motor, a time-varying voltage can be applied to the stator 2 and to the windings located therein, in order to generate a time-varying magnetic field, which acts in the rotor 3 to induce a torque and, thereby, generate a turning motion. When the electric machine 1 is operated as a generator, electrical energy can be generated by inducing a changing magnetic field (for example, by rotating the rotor 3) in a looped or coiled conductor of the stator 2, in order to induce a current in the conductor.

The stator 2 includes a stator core 7 and a stator cooling bush system 8 designed as two pieces, including an inner stator cooling bush 15 and including an outer stator cooling bush 20. The inner stator cooling bush 15 externally surrounds the stator core 7 in a radial direction r of the electric machine 1. The outer stator cooling bush 20 externally surrounds the stator cooling bush 15 in the radial direction r of the electric machine 1. The housing 4 externally surrounds the outer stator cooling bush 20 in the radial direction r of the electric machine 1.

The stator core 7 has a cylindrical inner cavity, in which the rotor 3 is arranged. The rotor 3 includes a multi-piece rotor shaft 36, which is mounted in a first antifriction bearing 11 and in a second antifriction bearing 12 so as to be rotatable about a longitudinal axis L of the electric machine 1. The longitudinal axis L extends in the axial direction of the electric machine 1. The stator core 7 and the stator cooling bush system 8 are fixedly (i.e., the stator core 7 and the stator cooling bush system 8 do not rotate) accommodated via a press fit in an axial bore 16 of the housing 4.

The inner stator cooling bush 15 forms a fluid duct 17, which is arranged between the stator core 7 and the outer stator cooling bush 20. In the exemplary embodiment shown, the fluid duct 17 extends helically around an outer lateral surface 31 of the inner stator cooling bush 15. The inner stator cooling bush 15 forms the fluid duct 17 by way of recesses at the outer surface 31 of the inner stator cooling bush 15. An inner lateral surface 22 of the outer stator cooling bush 20 closes the fluid duct 17 toward the outside in the radial direction r and seals off the fluid duct 17 in this direction. In the axial direction x, the fluid duct 17 is sealed by two O-rings 23, which are arranged between the inner stator cooling bush 15 and the outer stator cooling bush 20 at two axial end surfaces of the stator cooling bush system 8, which face away from each other.

The fluid duct 17 extends between the inner stator cooling bush 15 and the outer stator cooling bush 20 in such a way that cooling fluid (in particular, cooling water, for example, a mixture of water and antifreeze, such as Glysantin®) conveyed through the fluid duct 17 can cool the stator core 7. Cooling fluid that flows through the fluid duct 17 can absorb heat from the stator core 7. Subsequently or downstream, the cooling fluid can be re-cooled by a heat exchanger (not shown) of a fluid cooling circuit. The cooling fluid can be conveyed by a pump (not shown) of the fluid cooling circuit.

The outer stator cooling bush 20 forms multiple air ducts 18, of which one air duct 18 is shown by FIG. 1 and of which, by way of example in FIG. 3, a first air duct is provided with the reference character 18.1 and a second air duct is provided with the reference character 18.2. The air ducts 18, 18.1, 18.2 extend in an axial direction x of the electric machine 1 from a first end surface 24 of the outer stator cooling bush 20 up to a second end surface 28 of the outer stator cooling bush 20, wherein the outer stator cooling bush 20 forms multiple ridges, of which a first ridge 29.1, a second ridge 29.2, and a third ridge 29.3 are represented in FIG. 3.

The first ridge 29.1, the second ridge 29.2, and the third ridge 29.3 project outwardly from the outer lateral surface 30 in the radial direction r of the electric machine 1. The first ridge 29.1 and the second ridge 29.2 delimit the first air duct 18.1 between them in a circumferential direction U of the outer stator cooling bush 20. The second ridge 29.2 and the third ridge 29.3 delimit the second air duct 18.2 between them in the circumferential direction U of the outer stator cooling bush 20. The three ridges 29.1 through 29.3 are wide strips, which project from the outer lateral surface 30 merely with a low height in comparison to their width. In this way, very wide but low air ducts 18, 18.1, 18.2 arise. In the example embodiment shown, in particular, by FIG. 3, the ridges 29.1 through 29.3 are all identically shaped and arranged with equal spacing from one another (equidistantly) in the circumferential direction U and in parallel to one another. In the example embodiment shown by FIG. 3, the ridges 29.1 through 29.3 extend in a straight line and angled with respect to the axial direction x of the electric machine 1, and so the air ducts 18, 18.1, 18.2 extend diagonally along the outer lateral surface 30 of the outer stator cooling bush. Moreover, the ridges 29.1 through 29.3 form a radially outer support surface, with which the outer stator cooling bush 20—the elements of the electric machine 1 located radially within the outer stator cooling bush 20—can rest against the housing 4 of the electric machine. The ridges 29.1 through 29.3 are fitted into the bore 16 of the housing 4. The outer stator cooling bush 20 forms even further ridges and air ducts in the manner described above, although the further ridges and air ducts are not represented by FIG. 3.

The stator 2 also includes a first winding overhang 9 on a first end surface S1 of the electric machine 1 and a second winding overhang 10 on a second end surface S2 of the electric machine 1. The first winding overhang 9 is arranged within a first winding overhang space 13, which is represented on the left in FIG. 1 (first end surface S1). The second winding overhang 10 is arranged within a second winding overhang space 14, which is represented on the right in FIG. 1 (second end surface S2).

The first winding overhang space 13 is a hollow space. In an axial direction x of the electric machine 1, the first winding overhang space 13 is delimited by a housing part 19 of the housing 4, wherein the housing part 19 closes the electric machine 1 on the first end surface S1. The first winding overhang space 13 is also delimited externally, in a radial direction r of the electric machine 1, by the housing 4. Internally, in the radial direction r, the winding overhang space 13 transitions into a first rotor space 25. The first winding overhang space 13 and the first rotor space 25 are dry, i.e., no cooling fluid is located within the first winding overhang space 13 and within the first rotor space 25.

The second winding overhang space 14 is also a hollow space. In the axial direction x of the electric machine 1, the second winding overhang space 14 is delimited by the housing cover 5, which closes the electric machine 1 toward the outside on the second end surface S2. The second winding overhang space 14 is also delimited externally, in a radial direction r of the electric machine 1, by the housing 4. Internally, in the radial direction r, the second winding overhang space 14 transitions into a second rotor space 27. The second winding overhang space 14 and the second rotor space 27 are dry, i.e., no cooling fluid is located within the second winding overhang space 14 and within the second rotor space 27.

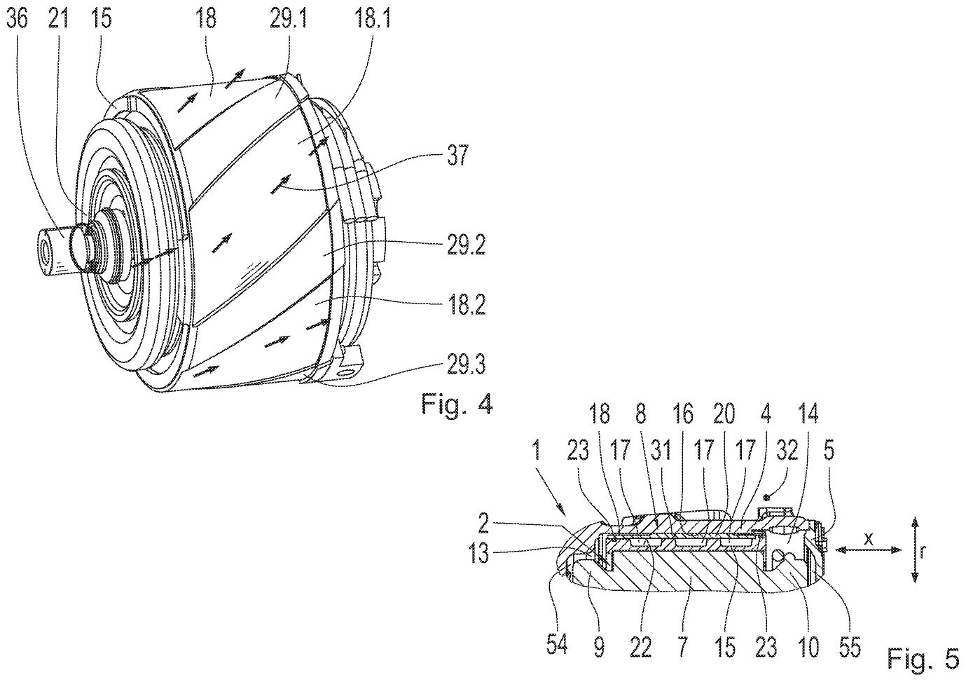

The rotor shaft 36 and the two winding overhangs 9, 10 are cooled by an air circulation that circulates within the electric machine 1 in a closed manner. The course of the air circulation is illustrated in FIGS. 1 and 4 by a series of flow arrows 37. A fan 53 is arranged within the air circuit 37 and conveys air located therein, and so the air circulates within the air circuit 37. The fan 53, in particular the fan wheel, is rotatably mounted on the rotor shaft 36 adjacent to the first rotor bearing 11 in the exemplary embodiment shown.

The air circuit 37 has a first winding overhang air duct 54 and a second winding overhang air duct 55. The first winding overhang air duct 54 and the second winding overhang air duct 55 extend, in the exemplary embodiment shown, in the radial direction r of the electric machine 1 from the inside toward the outside and along the first winding overhang 9 and along the second winding overhang 10, respectively. The end-surface housing part 19 delimits the first winding overhang air duct 54 on the first end surface S1. Air that flows through the first winding overhang air duct 54 absorbs heat from the first winding overhang 9. In this way, the first winding overhang 9 is cooled by air. The housing cover 5 delimits the second winding overhang air duct 55 on the second end surface S2. Air that flows through the second winding overhang air duct 55 absorbs heat from the second winding overhang 10. In this way, the second winding overhang 10 is cooled by air.

The air circuit 37 includes a rotor air duct 56 for cooling the rotor shaft 36. The rotor air duct 56 extends through the rotor shaft 36 in the axial direction x of the electric machine 1. The rotor shaft 36 forms the rotor air duct 56, for example, in that the rotor shaft 36 has a star-shaped cross-section. On the second end surface S2, the second air duct 55 opens into the second rotor space 27, which opens into the rotor air duct 56. In this way, the rotor air duct 56 is connected to the second air duct 55 via the second rotor space 27. Therefore, air can flow out of the second air duct 55 into the rotor air duct 56 via the second rotor space 27. On the first end surface S1, the rotor air duct 57 opens into the first rotor space 25, which opens into the first air duct 54. In this way, the rotor air duct 56 is connected to the first air duct 54 via the first rotor space 25. Therefore, air can flow out of the rotor air duct 56 into the first air duct 54 via the first rotor space 25. The air flowing through the rotor air duct 56 absorbs heat from the rotor shaft 36 and, as a result, cools the rotor shaft 36.

In order to cool down the air that had previously absorbed heat from the second winding overhang 10, from the rotor shaft 36, and from the first winding overhang 9, so that the air can subsequently absorb heat again from the aforementioned components in order to cool these components, the air flows through the air ducts 18, 18.1, 18.2 of the stator cooling bush system 8. On the first end surface S1, the first winding overhang air duct 54 opens into the first winding overhang space 13 (or the first winding overhang air duct 54 transitions into the first winding overhang space 13), which, in turn, opens into the air ducts 18, 18.1, 18.2. In this way, the air ducts 18, 18.1, 18.2 are connected to the first air duct 54 via the first winding overhang space 13. Therefore, air can flow out of the first winding overhang air duct 54 into the air ducts 18, 18.1, 18.2 via the first winding overhang space 13.

Air that flows out of the first winding overhang air duct 54 via the first winding overhang space 13 into the air ducts 18, 18.1, 18.2 can, on the one hand, give off heat to the housing 4, which can at least partially give off the absorbed heat to the external surroundings 32 of the electric machine 1. On the other hand, the air that flows through the air ducts 18, 18.1, 18.2 can give off heat to the cooling fluid that flows through the fluid duct 17.

In this way, the air that flows through the air ducts 18, 18.1, 18.2 is cooled down or re-cooled in both radial directions r (namely, radially inward and radially outward). On the second end surface, the air ducts 18, 18.1, 18.2 open into the second winding overhang space 14, which opens or transitions into the second winding overhang air duct 55. In this way, the air ducts 18, 18.1, 18.2 are connected to the second winding overhang air duct 55 via the second winding overhang space 14. Therefore, air can flow out of the air ducts 18, 18.1, 18.2 into the second winding overhang air duct 55 via the second winding overhang space 14. Since the air cools down while the air flows through the air ducts 18, 18.1, 18.2, cool air is available once again downstream from the air ducts 18, 18.1, 18.2 in order to cool, in particular, the second winding overhang 10, the rotor shaft 36, and the first winding overhang 9.

A direction of rotation of the rotor 3 is indicated in FIGS. 1 and 4 by a direction-of-rotation arrow 21. Due to the direction of rotation 21, which can correspond, for example, to a forward travel of the motor vehicle 6, 38, the air within the air circuit 37 begins to swirl. This is advantageous, in particular, within the diagonally extending air ducts 18, 18.1, 18.2, since, as a result, particularly good flow properties of the air can be achieved. In particular, only small eddies and a small back-up arise in the diagonally extending air ducts 18, 18.1, 18.2. In addition, the components 9, 10, 36 to be cooled can be particularly well impinged upon by the flow of air, wherein only a few “blind spots” with regard to the inflow arise.

FIG. 6 shows, merely by way of example, a drive train of a motor vehicle 6 having the electric machine 1 according to FIG. 1. In the exemplary embodiment shown, this is a hybrid vehicle 6. An internal combustion engine 33 can be coupled to a transmission 34, and so a torque can be transmitted from an output shaft of the internal combustion engine 33 onto an input shaft of the transmission 34. In a similar way, the electric machine 1 can be coupled to the transmission 34, and so a torque can be transmitted from an output shaft of the electric machine 1 onto an input shaft of the transmission 34.

The transmission 34 can therefore be a hybrid transmission, wherein the internal combustion engine 33 and/or the electric machine 1 can be coupled to the transmission 34. The transmission 34 can be an automatic transmission. A drive of the motor vehicle 6 can take place either via the internal combustion engine 33, the electric motor 1 (i.e., the electric machine 1 operated as a motor), or via a combination of both prime movers 1, 33. The purely exemplary drive train including the transmission 34 is a parallel hybrid having a P2 architecture in the exemplary embodiment shown, wherein the electric machine 1 is arranged between the internal combustion engine 33 and the transmission 34. The internal combustion engine 33 can be separated from the electric machine 1 and from the transmission 34 via a separating clutch 35.

FIG. 7 shows a further motor vehicle 38, for example, a commercial vehicle or a passenger car. The motor vehicle 38 has a drive train 39 (explained in greater detail in the following), which optionally enables an engageable and disengageable all-wheel drive. The drive train 39 includes a drive unit 40. The drive unit 40 in the exemplary embodiment shown includes a prime mover 41, for example, an internal combustion engine (for example, the internal combustion engine 33 according to FIG. 6), or an electric machine 1 of the type shown in FIG. 1, and a transmission 42 (for example, the transmission 34 according to FIG. 6). The drive unit 40 in the exemplary embodiment shown permanently drives, via a front differential gear 43, two front wheels 44 and 45, which are mounted at a front axle 46 of the motor vehicle 38.

Alternatively or additionally to the described front axle drive, the drive train 39 can include an engageable and disengageable electric axle drive 47, which, in the exemplary embodiment shown, includes an electric machine 1 according to FIG. 1 and a rear differential gear 48. The electric axle drive 47 can (as shown by FIG. 7) be designed as a central axle drive and, for example, drive a first rear wheel 49 via a first sideshaft 50 as well as a second rear wheel 51 via a second sideshaft 26. Alternatively, the first sideshaft 50 can also be driven via a first electric axle drive 47 and the second sideshaft 26 can also be driven via a second electric axle drive 47, wherein neither of the electric axle drives 47 then needs to have a differential gear 48.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

L longitudinal axis
r radial direction
S1 first end surface of the electric machine
S2 second end surface of the electric machine
U circumferential direction
x axial direction
1 electric machine
2 stator
3 rotor
4 housing
5 housing cover
6 motor vehicle
7 stator core
8 stator cooling bush system
9 first winding overhang
10 second winding overhang
11 first rotor bearing
12 second rotor bearing
13 first winding overhang space
14 second winding overhang space
15 inner stator cooling bush
16 axial housing bore
17 fluid duct
18 air duct
18.1 first air duct
18.2 second air duct
19 housing part on the first end surface
20 outer stator cooling bush
21 direction of rotation of the rotor
22 inner lateral surface of the outer stator cooling bush
23 O-ring
24 first end surface of the outer stator cooling bush
25 first rotor space
26 side shaft
27 second rotor space
28 second end surface of the outer stator cooling bush
29.1 first ridge
29.2 second ridge
29.3 third ridge
30 outer lateral surface of the outer stator cooling bush
31 outer lateral surface of the inner stator cooling bush
32 external surroundings of the electric machine
33 internal combustion engine
34 transmission
35 separating clutch
36 rotor shaft
37 air circuit
38 motor vehicle
39 drive train
40 drive unit
41 prime mover
42 transmission
43 front differential gear
44 front wheel
45 front wheel
46 front axle
47 electric axle drive
48 rear differential gear
49 first rear wheel
50 first sideshaft
51 second rear wheel
52 second sideshaft
53 fan
54 first air duct
55 second air duct
56 rotor air duct

1-10: (canceled)

11. An electric machine (1) for driving a motor vehicle (6, 38), comprising:
a stator (2) with a stator core (7),
a stator cooling bush system (8) externally surrounding the stator core (7) in a radial direction (r), the stator cooling bush system (8) forming a fluid duct (17) arranged within the stator cooling bush system (8), the stator cooling bush system (8) configured such that a fluid is flowable through the fluid duct (17) to receive heat from the stator core (7); and
a housing (4) externally surrounding the stator cooling bush system (8) in the radial direction (r),
wherein the stator cooling bush system (8) forms at least one air duct (18, 18.1, 18.2) arranged separately from the fluid duct (17) between the stator cooling bush system (8) and the housing (4),
wherein air is flowable through the at least one air duct (18, 18.1, 18.2), and the at least one air duct (18, 18.1, 18.2) is configured such that the air has previously absorbed heat from components (9, 10, 36) of the electric machine (1) to be cooled, and
wherein the fluid duct (17) and the at least one air duct (18, 18.1, 18.2) configured such that the fluid flowable through the fluid duct (17) receives heat from the air flowable through the at least one air duct (18, 18.1, 18.2).

12. The electric machine (1) of claim 11, wherein:
the stator cooling bush system (8) comprises a two-piece assembly with an inner stator cooling bush (15) and an outer stator cooling bush (20);
the inner stator cooling bush (15) externally surrounds the stator core (7) in the radial direction (r);
the outer stator cooling bush (20) externally surrounds the inner stator cooling bush (15) in the radial direction (r);
the housing (4) externally surrounds the outer stator cooling bush (20) in the radial direction (r);
the inner stator cooling bush (15) forms the fluid duct (17); and
the outer stator cooling bush (20) forms the at least one air duct (18, 18.1, 18.2).

13. The electric machine (1) of claim 12, wherein:
the air duct (18.1) extends in an axial direction (x) from a first end surface (24) of the outer stator cooling bush (20) to a second end surface (28) of the outer stator cooling bush (20);
the outer stator cooling bush (20) forms a first ridge (29.1) and a second ridge (29.2);
the first ridge (29.1) and the second ridge (29.2) project outwardly from an outer lateral surface (30) of the outer stator cooling bush (20) in the radial direction (r); and
the first ridge (29.1) and the second ridge (29.2) define the at least one air duct (18.1) between the first ridge (29.1) and the second ridge (29.2) in a circumferential direction (U).

14. The electric machine (1) of claim 13, wherein the first ridge and the second ridge extend in a straight line and in parallel to the axial direction (x) such that the at least one air duct also extends in parallel to the axial direction (x).

15. The electric machine (1) of claim 13, wherein the first ridge (29.1) and the second ridge (29.2) extend in a straight line and angled with respect to the axial direction (x) such that the at least one air duct (18, 18.1, 18.2) extends diagonally along the outer lateral surface (30) of the outer stator cooling bush (20).

16. The electric machine (1) of claim 13, wherein the first ridge (29.1) and the second ridge (29.2) form a radially outer support surface with which the outer stator cooling bush (20) rests against the housing (4) of the electric machine (1).

17. The electric machine (1) of claim 11, further comprising:
a closed air circuit (37); and
a fan (53) arranged within the closed air circuit (37),
wherein the at least one air duct (18, 18.1, 18.2) forms a section of the closed air circuit (37), and
wherein the fan (53) is operable to induce circulation of air within the closed air circuit (37).

18. The electric machine (1) of claim 17, further comprising a rotor (3) with a rotor shaft (36), wherein:
the air circuit (37) comprises a rotor air duct (56);
the rotor air duct (56) extends through the rotor shaft (36) in the axial direction (x); and
the rotor air duct (56) is configured such that air flowing in the rotor air duct (56) receives heat from the rotor shaft (36).

19. The electric machine (1) of claim 11, further comprising:
a first winding overhang air duct (54); and
a second winding overhang air duct (55),
wherein the first winding overhang air duct (54) extends along the first winding overhang (9) and is configured such that air flowing in the first winding overhang air duct (54) receives heat from the first winding overhang (9), and
wherein the second winding overhang air duct (55) extends along the second winding overhang (10) and is configured such that air flowing in the second winding overhang air duct (55) receives heat from the second winding overhang (10).

20. A motor vehicle (6, 38), comprising:
an electric axle drive (47); and
the electric machine (1) of claim 11,
wherein the electric machine (1) operable to drive the electric axle drive (47).
